(19) United States
(12) Patent Application Publication
(10) Pub. No.: US 2015/0186611 A1
(43) Pub. Date: Jul. 2, 2015

(54) PATIENT SUPPORT WITH DATA COMMUNICATION

(71) Applicant: Stryker Corporation, Kalamazoo, MI (US)

(72) Inventors: Christopher George, St. Thomas (CA); Robert Brunet, Komoka (CA)

(21) Appl. No.: 14/406,698

(22) PCT Filed: May 22, 2013
(86) PCT No.: PCT/CA2013/000495

§ 371 Date: Dec. 9, 2014

Related U.S. Application Data
(60) Provisional application No. 61/649,230, filed on May 18, 2012.

(51) Int. Cl. G06F 19/00; G06Q 50/22

(52) U.S. Cl. CPC G06F 19/3418; G06Q 50/22; G06Q 2220/10

(57) ABSTRACT

A patient support, such as a hospital bed, provided with a control circuit comprising a controller, memory, a communication interface, and a processor. The memory stores data related to the patient support. The controller includes a port, such as a USB port, or similar device, for providing an encryption key to the controller memory. The processor outputs data only when an encryption key is present in the memory. Before outputting in data, the processor may encrypt and/or digitally sign the data using the key. The outputting of data may be in response to an encrypted and/or digitally signed request.

### FIELD

This disclosure relates to patient supports, such as hospital beds, and more particularly, to patient supports having data communication capabilities.

### BACKGROUND

Patient supports, such as hospital beds or long-term care beds, produce and sometimes store data related to their operation. However, patient supports are limited in the ways in which they may communicate such data. Particularly, the security and privacy of patient support data may be a concern because such data may relate to the health of the occupant of the patient support or the operational parameters of the patient support.

There is a need for patient supports with improved data communication and improved methods of data communication in patient supports.

### SUMMARY

A key may be stored at a patient support. The presence of the key may be used to determine whether data may be output from the patient support. The key may be used to encrypt any data output by the patient support.

A request to the patient support for data may be digitally signed. The patient support may authenticate a signed request using the key.

Data stored at the patient support may be time-stamped with reference to a local clock that is synchronized with an external clock.

### BRIEF DESCRIPTION OF THE DRAWINGS

The drawings illustrate, by way of example only, embodiments of the present disclosure.

FIG. 1 is a perspective view of a height-adjustable patient support.

FIG. 2 is a side view of the patient support showing the raising and lowering mechanism.

FIG. 3 is a functional block diagram of a system for transferring data between a patient support and a device.

FIG. 4 is a flowchart of a method of transferring a encryption key to a patient support.

FIG. 5a is a flowchart of a method of transmitting data from a patient support.

FIG. 5b is a flowchart of a method of requesting data from a patient support.

FIG. 6 is a functional block diagram of an alternative embodiment of a system for transferring data between a patient support and a device.

FIG. 7 is a flowchart of a method of setting a clock of a patient support.

### DETAILED DESCRIPTION

As used herein, the term “patient support” refers to an apparatus for supporting a patient in an elevated position relative to a support surface for the apparatus, such as a floor. One embodiment of a patient support includes beds, for example hospital beds for use in supporting patients in a hospital environment. Other embodiments may be conceived by those skilled in the art. The exemplary term “hospital bed” may be used interchangeably with “patient support” herein without limiting the generality of the disclosure.

As used herein, the term “guard structure” refers to an apparatus mountable to or integral with a patient support that prevents or interferes with egress of an occupant of the patient support from the patient support, particularly egress in an unintended manner. Guard structures are often movable to selectively permit egress of an occupant of the patient support and are usually located about the periphery of the bed, for example on a side of the bed. One embodiment of a guard structure includes rails, for example side rails, mountable to a side of a patient support, such as a hospital bed. Other embodiments may be conceived by those skilled in the art. The exemplary terms “guard rail”, “side rail”, “rail structure” and the like may be used interchangeably with “guard structure” herein without limiting the generality of the disclosure.

As used herein, the term “control circuit” refers to an analog or digital electronic circuit with inputs corresponding to a patient support status or sensed condition and outputs effective to cause changes in the patient support status or a patient support condition. For example, a control circuit may comprise an input comprising an actuator position sensor and an output effective to change actuator position. One embodiment of a control circuit may comprise a programmable digital controller, optionally comprising or interfaced with an electronic memory module. Other embodiments may be conceived by those skilled in the art. The exemplary terms “controller”, “control system”, “control structure” and the like may be used interchangeably with “control circuit” herein without limiting the generality of the disclosure.

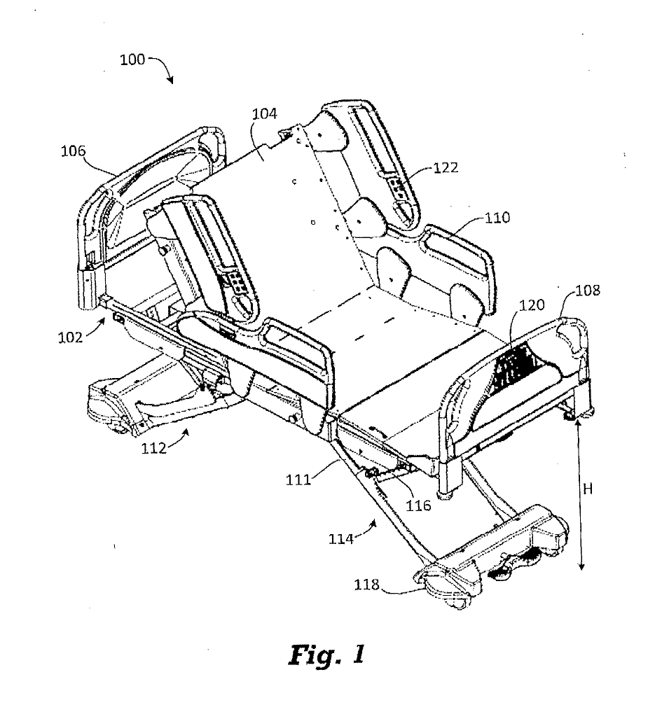

FIG. 1 illustrates an embodiment of a height-adjustable patient support 100. The patient support 100 includes a substantially horizontal frame 102 that supports an adjustable mattress support 104 positioned thereon to receive a person. For clarity, the mattress is not illustrated. The mattress support 104 has a upper-body portion capable of tilting up to form a backrest and tilting down to a prone position (tilt-up position shown). At the head end of the patient support 100 is a headboard 106, while a foot-board 108 is attached to the frame 102 at the foot end of the patient support 100. Guard structures comprising side rails 110 are positioned on each side of the patient support 100. Such side rails 110 may be moveable so as to facilitate entry and exit of a person. In this embodiment, the patient support 100 is a bed. In other embodiments, the patient support 100 may be a chair, wheelchair, stretcher, or similar apparatus. The term “patient” is intended to refer to any person, such as a hospital patient, nursing-home resident, or any other occupant of the patient support 100.

The patient support 100 includes two leg assemblies 112, 114, each having a pair of legs 111. The head leg assembly 112 is connected at the head end of the patient support 100 and the foot leg assembly 114 is connected at the foot end of the patient support 100. Upper portions of the legs 111 of the leg assemblies 112, 114 are connected to one or more linear actuators that may move the upper portions of the legs 111 back and forth along the length of the patient support 100. Leg braces 116 pivotably connected to the legs 111 and to the frame 102 constrain the actuator movement applied to the legs 111 to move the leg assemblies 112, 114 in a manner that raises and lowers the frame 102. In other words, the leg assemblies 112, 114 act as linkages that collapse and expand to respectively lower and raise the frame 102, whose height is indicated by H. The lower ends of the leg assemblies 112, 114 are connected to caster assemblies 118 that allow the patient support 100 to be moved to different locations.

Articulation of the mattress support 104 is controlled by actuators (not shown) that adjust the tilt of the upper-body portion of the mattress support 104 as well as the height of a knee-supporting portion of the mattress support 104.

The patient support 100 further includes an attendant's control panel 120 located at the foot-board 108. The attendant's control panel 120 may, among other things, control the height H of the frame 102, as well as the articulation of the mattress support 104. To allow for similar adjustment, an occupant's control panel 122 may be provided, for example, on a side rail 110.

The control panels 120, 122 include user interfaces such as buttons. The buttons may be membrane style buttons that operate as momentary contact switches (also known as “hold-and-run” switches). Buttons may be provided to raise the frame 102, lower the frame, articular the mattress support 104, set/pause/reset an exit alarm, zero an occupant weight reading, lockout controls, and to enable other functions. The control panels 120, 122 may have different sets of buttons for different sets of functions, with the attendant's control panel 120 typically having a wider array of functions available. Other styles of user interface and buttons, such as touch-screen buttons, are also suitable. The user interfaces of the control panels 120, 122 may include indicators, such as printed graphics or graphics on a display, for describing the functions of the buttons or other interface and as well as indicating data related to the patient support 100.

It should be emphasized that the patient support 100 is merely one example of a patient support that may be used with the techniques described herein. Other examples of patient support that may be so used include ultra-low type height-adjustable beds such as those disclosed in US Patent Publication No. 2011/113556 and U.S. Pat. No. 7,003,828, which are both incorporated herein by reference.

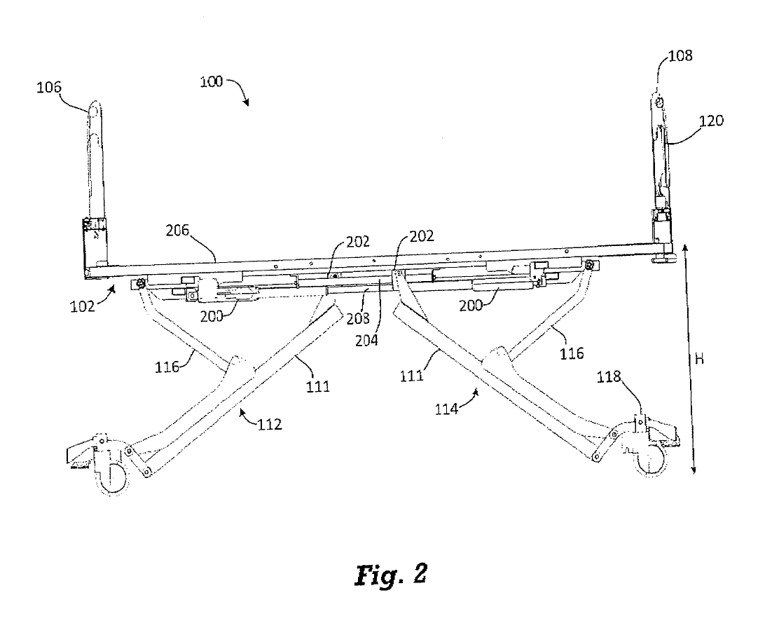

As shown in FIG. 2, one or more linear actuators 200 are provided to the leg assemblies 112, 114. Each linear actuator 200 has an extendable/retractable rod 208 that is connected to a bearing block 202, which slidably engages with a respective guide rod 204. The guide rods 204 are fixed to the frame 102. The upper portions of the legs 111 of each of the leg assemblies 112, 114 are pivotably connected to the respective bearing block 202. When the actuators 200 extend and retract, the bearing blocks 202 move linearly along the lengths of the guide rods 204. This linear motion is converted, via the additional constraint of the pivot-connected leg braces 116, to motion that raises and lowers the frame 102. Also illustrated is one of the elongate structural members 206 that, together with cross-members (not shown), form the frame 102. Although in this embodiment the patient support 100 has two actuators 200 for raising and lowering the frame 102, it should be understood that one or more actuators 200 may be used.

Each actuator 200 may include an actuator position sensor that may output a signal indicative of the position of the actuator 200 and thus the height of the frame 102 above the floor. For instance, the actuator position sensor may be a digital rotary encoder that outputs pulses to a controller, which may count the pulses to determine the position of the bearing block 202 and may further lookup or calculate a height of the frame 102 based on this count. A single actuator position sensor may be indicative of frame height when more than one actuator 200 is used. In other embodiments, other kinds of position or height sensors may be used and these need not be included in the actuator.

The actuators 200 may also be configured to move the patient support 100 into other positions, such as the Trendelenburg position (head lower than foot) or the reverse Trendelenburg position (head higher than foot).

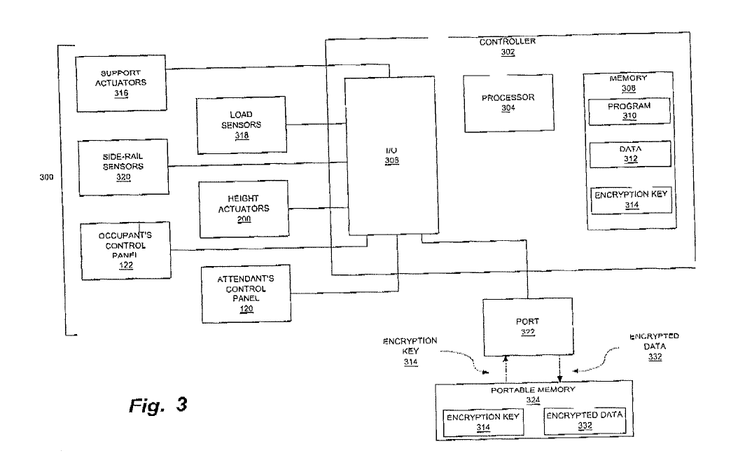

FIG. 3 shows a block diagram of a system 300 for controlling the patient support 100. Each of the components of the system 300 may be attached to the patient support 100 at a suitable location.

The system 300 includes a control circuit that comprises a controller 302 that includes a processor 304 electrically coupled to an input/output interface 306 and memory 308. The controller 302 may be situated in a control box that is attached or otherwise coupled to the patient support 100. The controller 302 may be physically integrated with another component of the system 300, such as the attendant's control panel 120.

The processor 304 may be a microprocessor, such as the kind commercially available from Freescale™ Semiconductor. The processor 304 may be a single processor or a group of processors that cooperate. The processor 304 may be a multicore processor. The processor 304 is capable of executing instructions obtained from the memory 308 and communicating with the input/output interface 306.

The memory 308 may include one or more of flash memory, dynamic random-access memory, read-only memory, and the like. In addition, the memory 308 may include a hard drive. The memory 308 is capable of storing data and instructions for the processor 304. Examples of instructions include compiled program code, such as a binary executable, that is directly executable by the processor 304 and interpreted program code, such as Java® bytecode, that is compiled by the processor 304 into directly executable instructions. Instructions may take the form programmatic entities such as programs, routines, subroutines, classes, objects, modules, and the like, and such entities will be referred to herein as programs, for the sake of simplicity. The memory 308 may retain at least some of the instructions stored therein without power.

The memory 308 stores a program 310 executable by the processor 304 to control operations of the patient support 100. The controller 302 comprising the processor 304 executing the program 310, which configures the processor 304 to perform actions described with reference to the program 310, may control, for example, the height of the frame 102, articulation of the mattress support 104 (e.g., upper-body tilt and knee height), exit alarm settings, and the like. The controller 302 may also be configured to obtain operational data from the patient support 100, as will be discussed below. Operational data obtained by the controller 302 may be used by the processor 304 and program 310 to determine control limits for the patient support 100.

The memory 308 also stores data 312 accessible by the processor 304. The data 312 may include data related to the execution of the program 310, such as temporary working data. The data 312 may additionally or alternatively include data related to properties of the patient support 100, such as a patient support serial number, model number, MAC address, IP address, feature set, current configuration, and the like. The data 312 may additionally or alternatively include operational data obtained from components, such as sensors and actuators, of the patient support 100. Operational data may include the height of the frame 102, an articulated state of the mattress support 104, a status of the side rails 110, an exit alarm setting or status, and an occupant weight. The data 312 may include historic data, which may be time-stamped. For example, the occupant's weight may be recorded several times a day in association with a timestamp. The data 312 may be stored in variables, data structures, files, data tables, databases, or the like. Any or all of the data mentioned above may be considered as being related to the patient support 100.

The input/output (I/O) interface 306 is configured to communicate information between the processor 304 and components of the system 300 outside the controller 302. The communication may be in the form of a discrete signal, an analog signal, a serial communication signal, or the like. The I/O interface 306 may include a bus, multiplexed port, or similar device. The input/output interface 306 may include one or more analog-to-digital converters. The I/O interface 306 allows the processor 304 to send control signals to the other components of the system 300 and to receive data signals from these components in what may be known as a master-slave arrangement.

The system 300 further includes components, such as one or more actuators 316 configured to control the articulation of the mattress support 104, one or more load sensors 318 (e.g., load cells) positioned to measure the weight of the occupant of the patient support 100, one or more side-rail sensors 320 configured to sense the position and/or locked state of a side rail 110, the frame-height actuators 200, the occupant's control panel 122, and the attendant's control panel 120. Each of the components may receive control signals from the controller 302, send data signals to the controller 302, or both.

The controller 302 is interconnected with one or more ports 322 via the I/O interface 306 of the controller 302. The port may be physical, such as a universal serial bus (USB) port, a memory card slot, a serial port, etc, or comprise structure for implementing short-range wireless communications using, for example, a Bluetooth™, near field communications (NFC), optical/infra-red, or similar communication protocol. The port 322 may be provided in any suitable location on the patient support. The I/O interface 306 is configured to implement an appropriate data transfer protocol to allow transfer of data between a connected external device and the controller 302, either uni-directionally from the device to the controller 302 or bi-directionally, via the port 322. Examples of suitable external devices include a data storage device, such as a flash drive, memory stick, memory card, etc. or a portable computer, such as a laptop, tablet, smartphone, or the like.

The port 322 preferably requires a physical connection (e.g., a cable or insertion of a card). When the port 322 comprises structure for implementing short-range wireless communications, the range may be limited to within, for example, 1-3 m. This is advantageous in that the connected device is constrained to be proximate to the patient support 100 when communicating, thereby increasing the security of such communication. That is, an unauthorized person would first have to gain physical access to the patient support 100 in order to communicate with it.

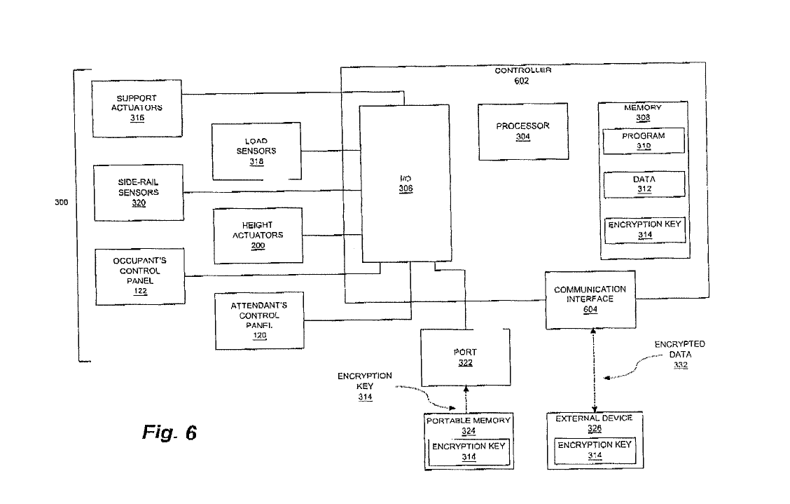

The port 322 may be used to communicate data between the patient support 100 and a connected device in a secure manner. The port 322 may be used in the encryption of data and/or in the authentication of the connected device as one which has been previously authorized to communicate with the patient support by personnel having physical access to the patient support. FIG. 3 describes an embodiment whereby data communication occurs through the port 322 itself, whereas FIG. 6 describes an embodiment whereby the port 322 is used to provide the required information for encryption and/or authentication, but data communication occurs through a separate communication interface (e.g. via Ethernet).

Still referring to FIG. 3, in this embodiment a portable memory device 324, such as a USB memory stick, is provided with an encryption key 314. The encryption key 314 belongs to either an asymmetric pair of cryptographic keys or is a symmetric cryptographic key that is generated on another device, such as a computer. In asymmetric encryption, data encrypted using the encryption key 314 may only reasonably be decrypted by a corresponding key; this is sometimes known as a public-private cryptographic key pair. In symmetric encryption, a common encryption key 314 is used by both the sender and receiver of communicated data. For asymmetric encryption, any public-key encryption scheme may be used, such as RSA, elliptic curve, or other asymmetric cryptographic technique. Available tools, such as Pretty Good Privacy (PGP), may be employed. For symmetric encryption, the encryption key 314 may be generated using known tools and techniques, for example by employing a passphrase or similar shared secret. Although the embodiments disclosed herein are described with reference primarily to a symmetric encryption key 314, persons of skill in the art will readily understand how asymmetric encryption keys could be employed.

The memory 308 of the patient support 100 is initially not provided with any encryption key 314 or is provided with an encryption key 314 that allows only for factory testing. The program 310 causes the processor 304 to monitor for and operate on a connection to the port 322 as follows. When the processor 304 (via I/O interface 306) detects a connection to the port 322, the processor 304 queries the connected device for the presence of the encryption key 314. If the encryption key 314 is detected, the processor 304 copies the encryption key 314 to the memory 308. For example, when a USB memory stick is used to deliver the encryption key 314, the program 310 includes a USB driver that monitors a data line of the USB port 322 and automatically initiates a USB connection to the USB memory stick when the data line is pulled high. The driver then triggers an event in the program 310 that automatically searches the USB memory stick for the encryption key 314 (e.g., via filename, filename extension or other pre-designated identifier) and then copies the encryption key 314, if found, to the memory 308. Afterwards, the program 310 may optionally delete the copy of the encryption key 314 on the USB memory stick. In this way, the portable memory device 324 may be used to distribute the encryption key 314 to one or more patient supports 100.

In another embodiment, the program 310 does not automatically find and copy the encryption key 314; rather, the program 310 provides for a file-system user interface at the attendant's control panel 120 to manually select and copy the encryption key 314 to the memory 308.

The program 310 does not permit outgoing communication of data 312 via the port 322 unless an encryption key 314 is present in the memory 308. This may be done in a number of ways, of which several will now be discussed. The program 310 may search the memory 308 for a file having a specific name or signature that indicates the presence of the encryption key 314. In the absence of a recognized encryption key with which to encrypt the data, no data is output via the port 322. Alternatively, the program 310 may read contents of a particular range of memory addresses reserved for the encryption key 314 to determine whether the encryption key 314 is present or not. The program 310 may perform validation to determine that the contents of a file or memory range is consistent with a encryption key. When the program 310 determines that a encryption key 314 is not present in the memory 308, the program 310 does not allow execution of instructions that cause the processor 304 to output data 312 to the port 322. For example, the program 310 may use a global Boolean variable to reflect the presence of a encryption key 314 (e.g., TRUE indicates the key is present and FALSE indicates the key is not present). Functions of the program 310 for outgoing data communication first check such variable before carrying out data outputting instructions. Both approaches advantageously provide enhanced data security.

It is advantageous that the controller 302 cannot output data without the presence of an encryption key 314 in its memory 308, as this prevents the operator of the patient support 100 from inadvertently exposing potentially sensitive or private information relating to the operation of the patient support 100 or the health of the occupant.

When the program 310 determines that an encryption key 314 is present in the memory 308, the program 310 allows execution of instructions that cause the processor 304 to output encrypted and/or digitally signed data 332. For example, data output functions are allowed to proceed with data outputting instructions that utilize the encryption key 314, or upon determining that the encryption key 314 is present in memory 308. The encryption key 314 is used by the processor 304 to either encrypt the data 312, to digitally sign the data 312, or both encrypt and digitally sign the data 312. Encryption of data 312 provides enhanced data security and obviates the need for a digital signature, since only data requests received from an authorized sender (as evidenced by the patient support being able to read the encrypted data request) are acknowledged by the patient support, and vice versa. Digital signatures are advantageous in that low computational overhead is required, by virtue of only the signature portion of the data request being encrypted using the encryption key 314; however, they are less secure. The combination of data encryption and digital signature is the most secure and most computationally intensive form of communication. The following embodiments describe the use of the encryption key 314 in providing encrypted data 332, but persons of skill in the art will understand that the encrypted data 332 could equally encompass digitally signed data and/or data that is both encrypted and signed.

As previously explained, the encrypted and/or signed data is output via the port 322 (FIG. 3) or via a communication interface 604 (FIG. 6).

Continuing with reference to FIG. 3, data output functions cause the processor 304 to encrypt data 312 and then output encrypted data 332 in response to predetermined events, such as a press of an “Export Data” button at the attendant's control panel 120 or the detection of a connection at the port 322 (i.e., similar to described above for delivering the encryption key 314), or a data request received by the patient support.

The program 310 preferably has a function or other set of instructions that causes the processor 304 to encrypt data 312 with the encryption key 314 to obtain encrypted data 332, which in this embodiment is made available via the port 322. This is advantageous in that sensitive medical data, such as the occupant's weight or bed exit alarm settings, are not widely readable. Instead, only devices having access to the encryption key 314 may readily decrypt data output at the port 322.

The program 310 may perform the encryption function on all or some of the data 312 as a request is made to output the data 312 to the port 322. Alternatively, the program 310 may perform the encryption function continually, so that all data 312 is encrypted.

Regarding retrieval of data from the patient support 100, a device, such as portable memory device 324, may be connected to the port 322. The portable memory device 324 may then be used to download data from the patient support 100. This may be achieved in a number of ways, of which several will now be discussed. In one embodiment, the program 310 encrypts all the data 312 and dumps it in encrypted form 332 to any device connected to the port 322 in response to detecting such device. In another embodiment, if the device 324 has computational capability, the program 310 may allow the device 324 to browse the data 312 and select part or all of the data 312 for download. Then, in response to a request from the device 324 to download data 312, the program 310 checks for the encryption key 314 and, if present, encrypts the requested data 312 before sending encrypted data 332 to the device 324 via the port 322. Alternatively, the program 310 may encrypt data 312 and make the encrypted data 332 available on the port 322 in response to a request received remotely or locally, for example via a button press, e.g., the “Export Data” button, at the attendant's control panel 120.

The device 324 that receives the encrypted data 332 may also store the encryption key 314 necessary for decrypting the encrypted data 332. This is advantageous when the encrypted data 332 is to be studied on site. Alternatively, the device 324 does not store the encryption key 314 and is merely used to ferry the encrypted data 332 to another device, such as a remote computer, that does store the encryption key 314. This is advantageous when a high degree of security is desired.

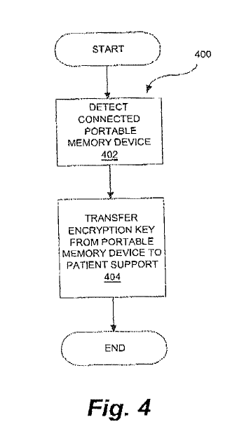

FIG. 4 illustrates a flowchart of a method 400 of transferring an encryption key to a patient support. The method 400 may be embodied in the program 310 discussed above. Although the method 400 is described in the context of the patient support 100, the method 400 may be applied to other patient supports.

First, at step 402, a portable memory device, such as a USB memory stick, is detected as connected to the port 322. This may be performed automatically by, for example, the driver for the port 322 detecting connections and allowing for software monitoring of such connections. Alternatively, this may be performed in response to human action by, for example, an attendant indicating to the controller 302 of the patient support 100 that the external device has been connected.

Next, an encryption key 314 stored on the external device is transferred to the patient support 100. This may be performed automatically by, for example, the controller 302 of the patient support 100 finding an encryption key 314 on the memory device 324 and moving or copying the encryption key to the patient support 100. Alternatively, this may be performed in response to human action by, for example, an attendant using a control panel 122 to move or copy the encryption key 314 from the memory device 324 to the patient support 100.

The connection of the memory device 324 to the port 322 is temporary, and thus once the encryption key 314 is transferred to the patient support 100, the memory device 324 may be disconnected from the port 322.

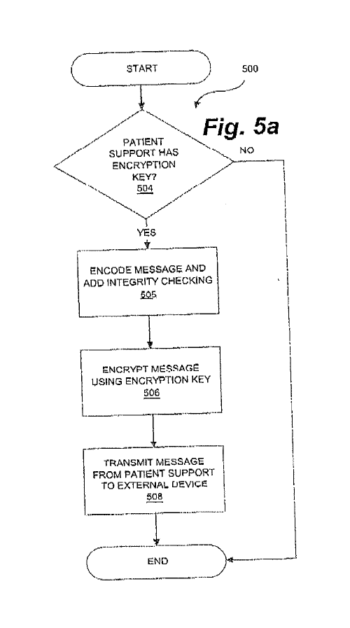

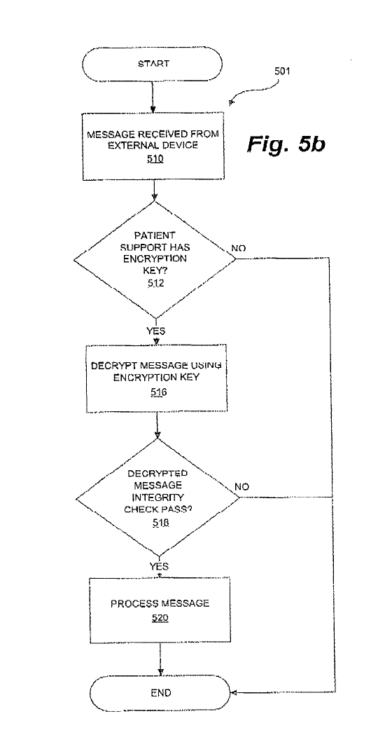

FIG. 5a illustrates a flowchart of a method 500 of sending data from a patient support. The method 500 may be embodied in the program 310 discussed above. Although the method 500 is described in the context of the patient support 100, the method 500 may be applied to other patient supports.

First, at step 502, a portable memory device 324, such as a USB memory stick or a portable computer, is detected as connected to the port 322. This may be performed automatically by, for example, the driver for the port 322 detecting connections and allowing for software monitoring of such connections. Alternatively, this may be performed in response to human action by, for example, a user of the memory device 324 setting up the connection using the controller 302 of the patient support 100. In another embodiment, it may be detected whether a remote computer is connected to a communication interface 604 (FIG. 6) of the patient support 100.

Then, at step 504, the controller 302 determines whether the memory 308 stores an encryption key 314 as a condition for carrying out the data transfer. If the encryption key is not present, then the method 500 ends and any request for transfer of data is unfulfilled. A suitable error message may be provided.

However, if the encryption key is present, then step 505 encodes the data 312 prior to encryption at step 506 with encryption key 314 to create encrypted data 332. A checksum (such as a CRC-32 checksum or similar) is also calculated for the entire encoded message and transmitted with the outgoing data 332 to verify data integrity. Optionally, a digital signature may be encrypted using the encryption key 314 for added security in authenticating the sender of the message.

Lastly, at step 508, the encrypted data 332 is transferred from the patient support 100 to the memory device 324 via the port 322.

FIG. 5b illustrates a flowchart of a method 501 of retrieving data from a patient support in response to a data request. The method 501 may be embodied in the program 310 discussed above. Although the method 501 is described in the context of the patient support 100, the method 501 may be applied to other patient supports.

At step 510, a message is received from an external device, such as the memory device 324 or, in another embodiment, remote computer(s) connected to the patient support 100 via the communication interface 604 (FIG. 6). The message is encrypted and optionally signed using the shared encryption key 314.

At step 512, the patient support determines whether or not a copy of the encryption key 314 is available in memory 308. If it is not, the message is ignored, since the patient support is unable to decrypt it. Otherwise, the message is decrypted at step 516 using the encryption key 314. The integrity of the decrypted message is verified at 518 by calculating a checksum and comparing it with the checksum generated for the originally encoded message prior to encryption and transmitted to the patient support 100. If the checksums are not equal, then there is a problem with data integrity and the message is ignored. Otherwise, the message is processed by the processor 304 at step 520. If the message comprises a request for specific data from the patient support 100, the data is encrypted using the encryption key 314 and transmitted as described with reference to FIG. 5a.

FIG. 6 shows a block diagram of a system 600 for transferring data between a patient support 100 and an external device 326, such as a computer. Differences between the system 600 and the system 300 will be discussed in detail below. For further description of features and aspects of the system 600, the description of the system 300 may be referenced. Features and aspects of the system 300 may be used with the system 600.

The system 600 includes a controller 602 that is similar to the controller 302 described above. The controller 602 further includes a communication interface 604 coupled to the I/O interface 306. The communication interface 604 may include a network adaptor, such as a wired Ethernet adapter or an adapter for radio frequency communication. A radio frequency communication adapter may include a wireless bridge connected to a wired Ethernet jack. The communication interface 604 uses standard network communication protocols, such as TCP/IP or a similar protocol, and allows the processor 304 to communicate over a network (signified in this figure by a dashed line).

A external device 326 connected to the network may then make requests for, and obtain encrypted data 332 from, the patient support 100 via the communication interface 604, in the manner discussed above with reference to FIGS. 5a and 5b.

The external device 326 may be a portable computer, a computer located in a facility, such as a hospital, that houses the patient support 100, or a computer located remote from the facility.

In one embodiment, the external device 326 may operate as a client in relation to the controller 602 of the patient support operating as the server. The processor 304 may execute a server process so that the controller 602 operates as a server. In another embodiment, the external device 326 is configured as a server and the controller 602 of the patient support is configured as a client. In yet another embodiment, the external device 326 and controller 602 are peers. It is noted that, in all embodiments, the encryption key 314 is delivered to the patient support 100 using the portable memory device 324, either by physically connecting the portable memory device 324 to the port 322 or by short-range wireless connection to the port 322.

When first connected to the facility network, the communication interface 604 is assigned a temporary lease with a unique IP address via the facility's DHCP server. Alternatively the DHCP server could be set up to issue a permanent lease of the same IP address for a patient support 100 each time it is connected to the network. For example, a unique MAC address associated with the communication interface 604 of the patient support 100 might always be provided with the same IP address by the facility's DHCP server. The choice of which method to use depends upon the facility's network configuration.

However, the patient support, once connected to the network, is unaware of the IP address of the external device 326 with which it needs to communicate. It needs a mechanism to find this address, otherwise it cannot participate in data communications via the communication interface 604.

In one embodiment, in order to find the IP address of the external device 326, an entry is made under a specific field in the facility's DNS server. The processor 304 is configured to check for this field and, if present, retrieves the IP address of the external device 326. In another embodiment, the external device 326 periodically sends an encrypted message with the device's IP address. For example, the IP address may be encoded along with each data request or sent on a regular schedule so that each patient support is regularly updated with an IP address that is stored in memory 308. The choice of method depends upon the facility's network configuration and whether there is a desire for communication to only be initiated in response to a request from the remote device 326 or self-initiated by the patient support 100.

A new encryption key 314 may be installed using the port 322 in a manner similar to that described above. It is preferable that only a single encryption key be stored in the memory 308 at any one time. To avoid inadvertent over-writing of the encryption key, an additional step may be included whereby a confirmation query is issued. The confirmation query is displayed locally, transmitted to the device connected to port 322, and/or transmitted over the communication interface 604 to a previously authenticated remote device 326. For example, the confirmation query may be transmitted over the communication interface 604, via TCP/IP or similar, in an encrypted and/or digitally signed manner using the original encryption key. The query is confirmed by the remote device 326, which is configured with both the new encryption key 314 and the original encryption key. Only upon confirmation from the remote device 326 will the encryption key in memory 308 be overwritten with the new encryption key 314. The controller 302 or 602 may then signify to the remote device 326 that the new encryption key 314 has been accepted by sending an encrypted and/or digitally signed receipt message generated using the new encryption key 314. In an alternative embodiment, the new encryption key 314 is temporarily written to the memory 308 and a simple confirmation data string is encrypted using the new encryption key 314 for transmission to the associated computer. If the data string is successfully decrypted by the associated computer, which is confirmed to the patient support by issuance of a properly encrypted response created using the new encryption key 314, then the new encryption key 314 is overwritten to the memory 308.

Any suitable asymmetric or symmetric cryptographic technique may be used. For example, other embodiments may use hashing, dictionary or substitution cyphers, data obfuscation using a human selected key such as a password, and similar. The specific technique used may be selected based on the level of security desired and the level of complexity that may be tolerated.

In the embodiments described herein, the patient support stores one encryption key. In an alternative embodiment, the patient support may store multiple encryption keys to communicate with multiple external devices having different corresponding keys. In addition, when multiple patient supports are provided, each may store a copy of the same encryption key to communicate with the same external device that holds the corresponding key. In this case, digital signatures may be used to differentiate between patient supports.

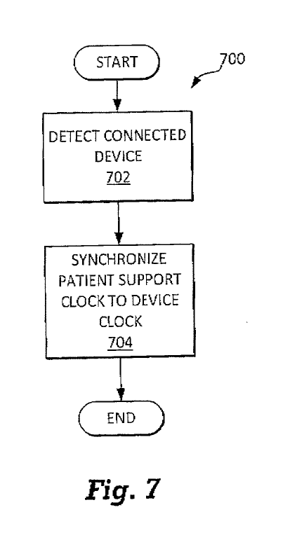

As mentioned above, data stored at the patient support 100 may be time-stamped. This is particularly useful when the patient support 100 is configured to periodically record data, such as patient weight or alarm triggering history. When the patient support 100 is connected to an external device 326, such as a computer, a program of the patient support 100, such as the program 310, may synchronize the time stored at the patient support 100 with the time at the external device. The time at the patient support may be tracked by a local clock of the controller 302 or 602, for example. The local clock may be a hardware component of the controller or may be part of the program 310. Synchronizing time in this manner is depicted in the flowchart of FIG. 7 as method 700. The method 700 is described with reference to the patient supports described herein, but may be used with other patient supports as well.

At step 702, the controller of the patient support detects an external device 326, such as a computer, connected to the patient support. The external device may be, for example, a portable computer directly connected to the patient support, a remote client or server computer connected via a network to the patient support, or similar clock-bearing electronic device.

Then, at step 704, the controller synchronizes the local clock of the patient support to the clock of the external device. This may be achieved by the controller requesting a time from the external device and then setting the time at the patient support upon receiving the time from the external device.

The method 700 is advantageous in that data output by the patient support 100 is time-stamped by a local clock that is synchronized to a reference clock external to the patient support 100. Drift or error in the local clock of the patient support 100 is corrected each time the external device is connected to the patient support 100.

Programs detailed herein are described in terms of software, hardware, or firmware for sake of convenience. Software, hardware, firmware, or various combinations of such may be used to realize any of the programs described herein.

While the foregoing provides certain non-limiting example embodiments, it should be understood that combinations, subsets, and variations of the foregoing are contemplated. The monopoly sought is defined by the claims.

What is claimed is:

1. A method of outputting data from a patient support, the method comprising:
determining whether an encryption key is present in memory at the patient support as a condition for outputting the data; and
when the encryption key is present, outputting the data.

2. The method of claim 1, further comprising encrypting the data using the encryption key to obtain encrypted data.

3. The method of claim 1, further comprising digitally signing the data using the encryption key.

4. The method of claim 1, wherein the method further comprises receiving a request at the patient support to output data.

5. The method of claim 4, wherein the request is digitally signed, the method further comprising authenticating the request using the key as another condition for outputting the requested data.

6. The method of claim 4, wherein the request is received from an external device via a communication interface of the patient support.

7. The method of claim 6, wherein the external device is a remote computer.

8. The method of claim 4, wherein the request is received from a user interface of the patient support.

9. The method of claim 1, further comprising receiving the encryption key from a memory device.

10. The method of claim 9, wherein the memory device is at least temporarily connected to the patient support via a physical connection or short-range wireless connection.

11. The method of claim 10, wherein receiving the encryption key from the memory device is performed automatically in response to detecting that the memory device is connected to the patient support.

12. The method of claim 1, wherein the encryption key comprises a symmetric cryptographic key.

13. A patient support comprising:
a memory configured to store data related to the patient support;
a communication interface; and
a processor coupled to the memory and the communication interface, the processor configured to output data via the communication interface conditional upon determining that an encryption key is present in the memory.

14. The patient support of claim 13, wherein the processor is further configured to encrypt the data using the encryption key prior to outputting the data.

15. The patient support of claim 13, wherein the processor is further configured to respond to a request to output data, the request being received at the patient support from an external device.

16. The patient support of claim 15, wherein the request is encrypted and wherein the processor is further configured to decrypt the request using the encryption key.

17. The patient support of claim 15, wherein the request is digitally signed and wherein the processor is further configured to authenticate the request using the encryption key.

18. The patient support of claim 13, further comprising receiving the encryption key from a memory device.

19. The patient support of claim 18, wherein the memory device is at least temporarily connected to the patient support via a physical connection or short-range wireless connection.

20. The patient support of claim 19, wherein the processor is further configured to detect at the port a connection of the memory device.

21. The patient support of claim 20, wherein the processor is further configured to store the encryption key in the memory automatically in response to detecting the connection of the memory device.

22. The patient support of claim 13, wherein the key comprises a symmetric cryptographic key.

23. A method of outputting data from a patient support, the method comprising:
detecting connection of an external device to the patient support, the external device being an electronic clock-bearing device;
receiving a time from the external device;
setting a clock of the patient support to the time received from the external device; and,
outputting data from the patient support to the external device via a communication interface, the data bearing a time stamp received from the clock of the patient support.

24. The method of claim 23, wherein the data is output from the patient support conditional upon determining that an encryption key is present in a memory of the patient support.

25. The method of claim 24, wherein the method further comprises encrypting the data using the encryption key prior to outputting the data.
